(19) United States
(12) Patent Application Publication
(10) Pub. No.: US 2024/0046124 A1
(43) Pub. Date: Feb. 8, 2024

(54) COMPUTER SYSTEM

(71) Applicant: Hitachi, Ltd., Tokyo (JP)

(72) Inventors: Kohei MATSUSHITA, Tokyo (JP); Masayoshi MASE, Tokyo (JP); Yasuhide MORI, Tokyo (JP)

(21) Appl. No.: 18/223,696

(22) Filed: Jul. 19, 2023

(30) Foreign Application Priority Data
Aug. 2, 2022 (JP) 2022-123153

(51) Int. Cl. G06N 5/04

(52) U.S. Cl. CPC G06N 5/04

(57) ABSTRACT

A computer system includes an arithmetic device and a storage device. The storage device stores a model configured to output an action predicted based on an action value in response to input data. The arithmetic device is configured to acquire data to be explained including values of a plurality of components to be explained in order to explain first prediction processing of the model that outputs a first predicted action in response to first input data, determine contributions of each of the plurality of components to be explained to an action value and an uncertainty of the action value in the first prediction processing, detect one or more risk components in the first prediction processing from the plurality of components to be explained based on the contributions, and present information on the risk components.

### CROSS-REFERENCE TO RELATED APPLICATION

The present application claims priority from Japanese patent application JP 2022-123153 filed on Aug. 2, 2022, the content of which is hereby incorporated by reference into this application.

### BACKGROUND

This disclosure relates to a computer system, for example, a computer system for supporting the user in decision-making.

Background art of this disclosure includes WO 2022/024559 A. This document discloses a medical assistance system that assists a medical act performed by a doctor. For example, it discloses: The medical assistance system comprises a control unit, a recognition unit that recognizes the surgical field environment, and a machine learning model that estimates an action to be performed by the medical assistance system on the basis of the result of recognition by the recognition unit. The control unit outputs evaluation basis information pertaining to the action estimated by the machine learning model to an information presentation unit. The control unit is furthermore provided with a computation unit that calculates a degree of reliability pertaining to the result of estimation by the machine learning model, and the control unit outputs the degree of reliability to the information presentation unit (Abstract).

### SUMMARY

In applying a planning model utilizing reinforcement learning or mathematical optimization to supporting human decision-making, interpretability could be an issue. For example, conventional models do not provide any clue indicating what situation the model has counted for in generating the proposal or whether a better proposal exists. Accordingly, demanded is a technique that increases the interpretability of a plan recommended by a model to effectively support human decision-making.

A computer system according to an aspect of this disclosure includes an arithmetic device and a storage device. The storage device stores a model configured to output an action predicted based on an action value in response to input data. The arithmetic device is configured to acquire data to be explained including values of a plurality of components to be explained in order to explain first prediction processing of the model that outputs a first predicted action in response to first input data, determine contributions of each of the plurality of components to be explained to an action value and an uncertainty of the action value in the first prediction processing, detect one or more risk components in the first prediction processing from the plurality of components to be explained based on the contributions, and present information on the risk components.

An aspect of this disclosure can support human decision-making effectively. The problems, configurations, and effects other than those described above are clarified in the following description of embodiments.

### BRIEF DESCRIPTION OF THE DRAWINGS

FIG. 1 is a diagram illustrating an example of the hardware configuration of a computer system including a decision-making support system in an embodiment of this specification.

FIG. 2 is a diagram illustrating an example of the software configuration of the computer system.

FIG. 3 provides an example of the structure of information included in a state to be sent from an operation management system to a decision-making support system.

FIG. 4 provides an example of the structure of information included in a predicted action to be provided by an action prediction unit.

FIG. 5 provides an example of the structure of information included in an action value and its uncertainty to be provided by the action value prediction unit.

FIG. 6 provides an example of the structure of information included in contributions of components to action value and its uncertainty to be generated by an XAI execution unit.

FIG. 7 provides an example of the structure of information included in a revised action to be proposed by the revised action search unit.

FIG. 8 provides an example of the structure of information included in evaluation scores of original and revised actions to be generated by the action evaluation unit.

FIG. 9 is a flowchart of an embodiment of the processing in which a reinforcement learning model, specifically a Q-learning model, is applied to power operation management.

FIG. 10 is a flowchart of an example of the method of extracting high-risk components at Step S13.

FIG. 11 is a flowchart of another example of the method of extracting high-risk components at Step S13.

FIG. 12 provides an example of an XAI configuration screen.

FIG. 13 provides an example of a risk factor presentation screen.

FIG. 14 provides an example of a revised action presentation screen to be generated by a revised action presentation unit.

FIG. 15 provides an example of an action evaluation result screen.

### DETAILED DESCRIPTION OF EMBODIMENTS

Hereinafter, embodiments of this invention are described in detail with reference to the drawings. Although the description is provided in separate sections or embodiments as necessary for convenience, they are not irrelevant to one another but one can be a modification, specifics, or a supplemental explanation of a part or all of another unless specified otherwise. Furthermore, the number of elements (inclusive of the numerical value, amount, and range of an element) is not limited to the specific number referred to in the following description but can be a number larger or smaller than the specific number unless particularly specified or obviously limited to the number in principle.

A system in an embodiment of this specification can be a physical computer system (consisting of one or more physical computers) or a system constructed of computing resources (multiple computing resources) like a cloud platform. The computer system or computing resources can include one or more interface devices (including a communication device and an input and output device, for example), one or more storage devices (including a memory (primary storage device) and an auxiliary storage device, for example), and one or more arithmetic devices.

When a computer program including operation codes is executed by an arithmetic device to perform a function, the arithmetic device performs predetermined processing using the storage devices and/or the interface devices as necessary. Accordingly, the function can be defined as at least a part of the arithmetic device. The processing described by a sentence having a subject of the function can be regarded as the processing performed by the arithmetic device or the system including the arithmetic device. The program can be installed from a program source.

The program source can be a program distribution computer or a computer-readable storage medium (such as a computer-readable non-transitory storage medium). The described functions are examples; a plurality of functions can be integrated into one function or one function can be separated into a plurality of functions.

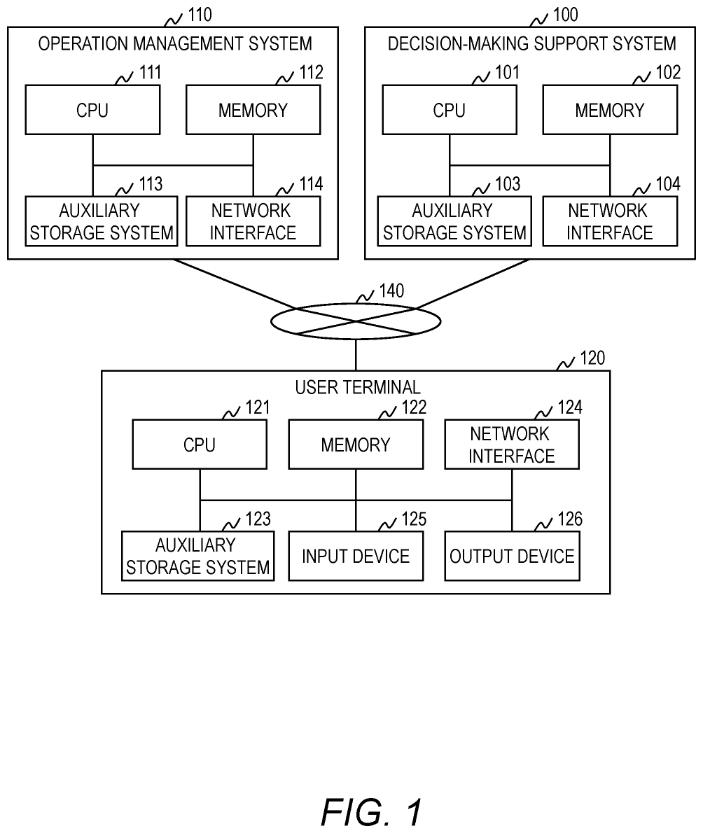

FIG. 1 is a diagram illustrating an example of the hardware configuration of a computer system including a decision-making support system in an embodiment of this specification. The computer system in FIG. 1 includes an operation management system 110, a decision-making support system 100, and a user terminal 120. These apparatuses are interconnected via a network 140. The network 140 can be of any type, such as wide area network (WAN) or local area network (LAN). The connection to the network 140 can be either wired or wireless.

The operation management system 110 operates and manages the target system of the user terminal. Examples of the operation management system 110 include a power grid operation management system, a railroad operation management system, a supply chain operation management system, and a factory line operation management system. The following description is mostly about an example of the power grid operation management system.

The hardware configuration of the operation management system 110 includes a CPU 111, a memory 112, an auxiliary storage device 113, and a network interface 114. The hardware components communicate with one another via an internal bus. The CPU 111 executes programs stored in the memory 112. The memory 112 stores programs to be executed by the CPU 111 and information required for the programs. The memory 112 includes a work area to be used by the programs temporarily.

The auxiliary storage device 113 persistently stores data. The auxiliary storage device 113 can be a storage medium such as an HDD (hard disk drive) or an SSD (solid-state drive) or a non-volatile memory. The programs and information stored in the memory 112 can be stored in the auxiliary storage device 113. In this case, the CPU 111 retrieves a program and information from the auxiliary storage device 113, loads them to the memory 112, and executes the program loaded to the memory 112. The network interface 114 connects the operation management system 111 to another apparatus via the network.

The decision-making support system 100 generates information for supporting decision-making of a user of the operation management system 100 and presents the information to the user. In addition, the decision-making support system 100 receives an instruction from the user and forwards it to the operation management system 110. The instruction for the operation management system 110 can be directly sent from the user terminal 120 to the operation management system 110.

The hardware configuration of the decision-making support system 100 includes a CPU 101, a memory 102, an auxiliary storage device 103, and a network interface 104. The hardware components communicate with one another via an internal bus. The CPU 101, the memory 102, the auxiliary storage device 103, and the network interface 104 are hardware components similar to the CPU 111, the memory 112, the auxiliary storage device 113, and the network interface 114, respectively.

The user terminal 120 is a terminal to be used by a user. The user terminal 120 receives a user input to generate an explanation of a policy model and presents an explanation of the basis of inference by a policy model to the user. The hardware configuration of the user terminal 120 includes a CPU 121, a memory 122, an auxiliary storage device 123, a network interface 124, an input device 125, and an output device 126. The hardware components communicate with one another via an internal bus.

The CPU 121, the memory 122, the auxiliary storage device 123, and the network interface 124 are hardware components similar to the CPU 111, the memory 112, the auxiliary storage device 113, and the network interface 114, respectively.

The input device 125 is a device for inputting data; examples of the input device 125 include a keyboard, a mouse, and a touch panel. The output device 126 is a device for outputting data; examples of the output device 126 include a display and a touch panel.

In each of the above-described apparatuses, the CPU performs processing in accordance with a program to work as a function unit having a predetermined function. In the following description, when some processing is described using a program as an agent, it means that the CPU or the apparatus including the CPU executes the program for implementing the function unit.

In the configuration example in FIG. 1, different computers separately execute tasks of operation management, decision-making support, and user interface. In another example, all of the tasks or a combination of some tasks can be executed by one computer. For example, the operation management system 110 and the decision-making support system 100 can be implemented as virtual machines running on a single computer.

As described above, a computer system can be constructed of one or more computers each including one or more arithmetic devices and one or more storage devices including a non-transitory storage device. A memory, an auxiliary storage device, or a combination of those is a storage device. A CPU is an example of an arithmetic device. The arithmetic device can be composed of a single processing unit or multiple processing units and can include a single or multiple arithmetic units or multiple processing cores. The arithmetic device can be implemented as one or more central processing units, microprocessors, microcomputers, microcontrollers, digital signal processors, state machines, logic circuits, graphic processing units, systems-on-a-chip, and/or any devices that operate a signal in accordance with a control command.

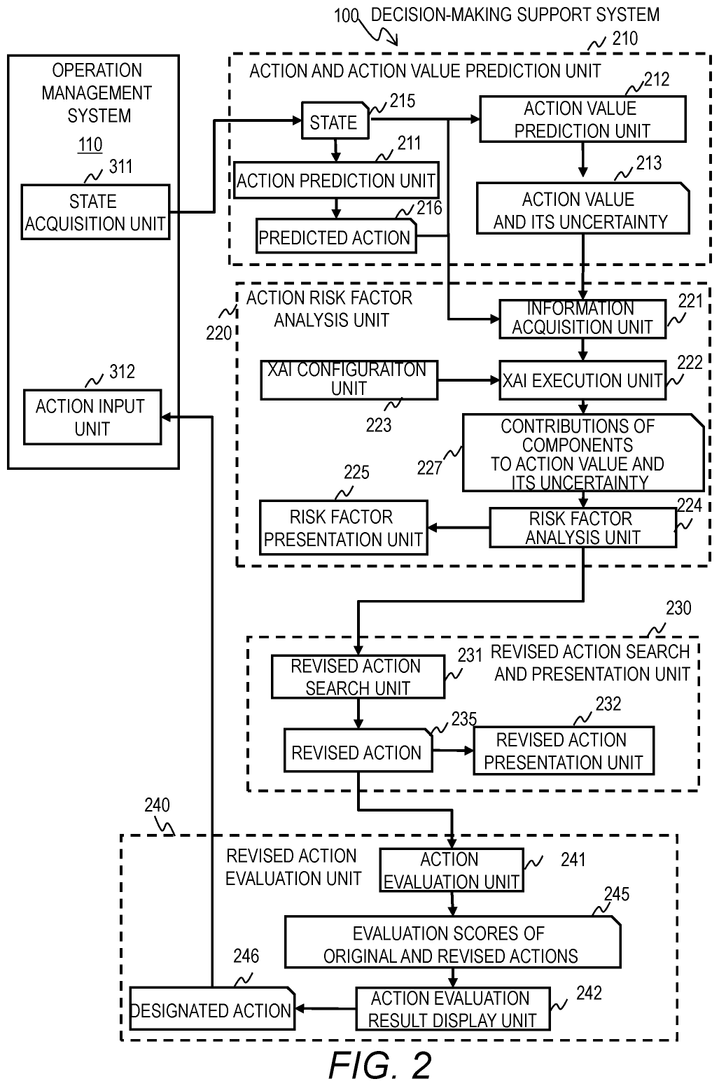

FIG. 2 is a diagram illustrating an example of the software configuration of the computer system, specifically, program modules in the operation management system 110 and the decision-making support system 100 together with the outline of their processing.

The operation management system 110 includes a state acquisition unit 311 and an action input unit 312. The state acquisition unit 311 acquires information on the current state of the system to be managed. The action input unit 312 acquires information on the next action of the system from the decision-making support system 100.

The decision-making support system 100 includes an action and action value prediction unit 210, an action risk factor analysis unit 220, a revised action search and presentation unit 230, and a revised action evaluation unit 240. The action and action value prediction unit 210 includes an action prediction unit 211 and an action value prediction unit 212.

The action prediction unit 211 acquires information on the current state 215 of the system to be managed from the state acquisition unit 311 of the operation management system 110 and predicts a next action 216 optimum for the system based on the state 215. The action prediction unit 211 can include an explanatory variable different from the state 215 such as a variable about an environment and also, can be provided with a restriction.

The action value prediction unit 212 predicts the value of the predicted action and its uncertainty 213 based on the state 215 of the system and the action 216 predicted by the action prediction unit 211. The action and action value prediction unit 210 can be configured of any kind of algorithm for predicting an action and the value of the predicted action, such as a reinforcement learning model, an imitative learning model, and a decision tree. This specification describes an example utilizing reinforcement learning.

The action risk factor analysis unit 210 includes an information acquisition unit 221, an XAI (eXplainable Artificial Intelligence) execution unit 222, an XAI configuration unit 223, a risk factor analysis unit 224, and a risk factor presentation unit 225.

The information acquisition unit 221 acquires information to be processed from the action and action value prediction unit 210. Specifically, the information acquisition unit 221 acquires information on the current state 215 of the system, the action 216 predicted by the action prediction unit 211, and the action value and its uncertainty 213 predicted by the action value prediction unit 212.

The XAI execution unit 222 calculates contributions 227 of designated input components to the action value and its uncertainty 213. The XAI execution unit 222 calculates contributions 227 of individual input components to each of the action value and its uncertainty. The XAI execution unit 222 resolves each of the action value and its uncertainty into contributions of individual components.

The XAI execution unit 222 can calculate the contributions by any kind of algorithm. For example, the XAI execution unit 222 can utilize SHAP (Shapley Additive Explanations), LIME (Local Interpretable Model-Agnostic Explanations), or integrated gradient.

The XAI configuration unit 223 acquires configuration data for the XAI execution unit 222 from the user terminal 120 and configures the XAI execution unit 222. The XAI configuration unit 223 displays a configuration screen on the user terminal 120 and receives configuration information input through the configuration screen from the user terminal 120. Although the details of the configuration will be described later, the kinds and the values of the components to be explained whose contributions are to be calculated and the action value prediction model to be explained are designated.

The risk factor analysis unit 224 analyzes the contributions 227 of the components to the action value and the uncertainty of the action value to determine the component working as a risk factor for the action value and the uncertainty of the action value. For example, the risk factor analysis unit 224 determines that a component negatively contributing to both of the action value and its uncertainty, namely, a component impairing the action value and increasing the uncertainty of the action value, is a risk factor.

The risk factor presentation unit 225 presents the analysis result of the risk factor analysis unit 224 to the user. In this example, the risk factor presentation unit 225 generates a screen indicating the analysis result of the risk factor analysis unit 224 and displays it on the user terminal 120.

The revised action search and presentation unit 230 includes a revised action search unit 231 and a revised action presentation unit 232. The revised action search and presentation unit 230 acquires the analysis result of the risk factor analysis unit 224 together with the action 216 predicted by the action prediction unit 211 from the action risk factor analysis unit 220.

The revised action search unit 231 analyzes the analysis result of the risk factor analysis unit 224 and searches for a revised action 235 for the optimum action 216 predicted by the action prediction unit 211. The revised action presentation unit 232 presents the revised action 235 proposed by the revised action search unit 231 to the user. In this example, the revised action presentation unit 232 generates a screen indicating the revised action 235 proposed by the revised action search unit 231 and displays it on the user terminal 120.

The revised action evaluation unit 240 includes an action evaluation unit 241 and an action evaluation result display unit 242. The revised action evaluation unit 240 acquires one or more revised actions 235 proposed by the revised action search unit 231 and the action 216 predicted by the action prediction unit 211 from the revised action search and presentation unit 230.

The action evaluation unit 241 outputs evaluation of each revised action 235 proposed by the revised action search unit 231 in response to input of the revised action. For example, the action evaluation unit 241 performs Monte Carlo simulation for calculating an expectation in a reinforcement learning environment including stochastic behaviors or time evolution simulation with the action prediction unit 211.

In this example, the revised action evaluation unit 240 calculates evaluation scores 245 of the original action of the revised action, namely the action 216 predicted by the action prediction unit 211, and the revised action 235. The action evaluation result display unit 242 presents the evaluation result of the action evaluation unit 241 to the user. In this example, the action evaluation result display unit 242 generates a screen indicating the evaluation result of the action evaluation unit 241 and displays it on the user terminal 120.

In consideration of the presented evaluation scores, the user designates the action 246 to instruct the operation management system 110 to take through the user terminal 120. The designated action 246 can be one of the predicted action 216, the revised action 235, and either action amended by the user. The action input unit 312 of the operation management system 110 acquires the action 246 designated by the user from the revised action evaluation unit 240 and instructs the system to do the action 246.

Hereinafter, an example of a reinforcement learning algorithm for power operation management is described. The operation management system 110 operates and manages a plurality of power generators and controls their outputs. The outputs of the power generators should be determined appropriately depending on the failure probabilities of the power generators and the demand for power. The decision-making support system 100 predicts an optimum action for the operation management system 110 using a reinforcement learning algorithm.

Examples of the reinforcement learning algorithm include an actor-critic algorithm and a Q-learning algorithm. The model can be any type of model including a model utilizing a deep neural network or tables. In the following description, the action value is referred to as Q-value. The Q-value is an expectation for a long-term reward; in the example of power operation management, it is an expectation for the cost for power generation and the damage by power outage.

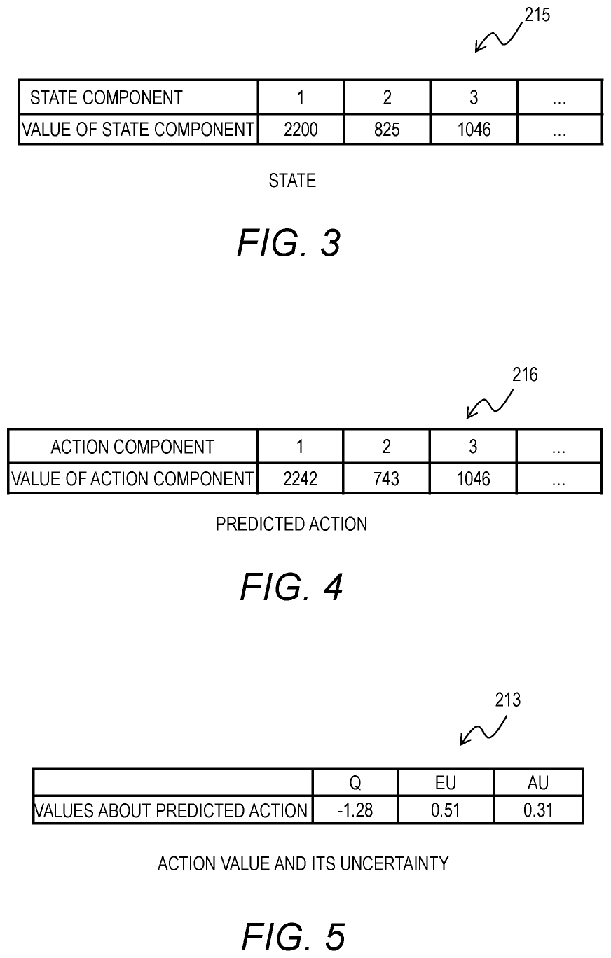

Examples of data structures in the power operation management are described. FIG. 3 provides an example of the structure of information included in a state 215 to be sent from the operation management system 110 to the decision-making support system 100. The state 215 indicates values of individual components of the state. In the example of the power operation management, each component can be a power generator and the value of the state component can be the current output of the power generator.

FIG. 4 provides an example of the structure of information included in a predicted action 216 to be provided by the action prediction unit 211. The predicted action 216 indicates values of individual components of the action. In the power operation management, each component of the action can be a power generator, like the component of a state. The value of the action component indicates the output of the power generator in the next step.

FIG. 5 provides an example of the structure of information included in an action value and its uncertainty 213 to be provided by the action value prediction unit 212. The action value and its uncertainty 213 indicates the Q-value of the predicted action 216, the epistemic uncertainty (EU), and the aleatoric uncertainty (AU). The Q-value represents the action value. The epistemic uncertainty and the aleatoric uncertainty are uncertainties of the Q-value.

Various methods for quantifying the uncertainty of an inference result of machine learning have been proposed. The uncertainty of an inference result is resolved into two kinds of uncertainties: epistemic uncertainty caused by shortage of learning data and aleatoric uncertainty caused by noise included in the data.

In a regression problem, the uncertainty can be defined as follows, using the variance among the values predicted by a plurality of models learned from the same learning data set. Let μi be the values predicted by the models i (i=1 to N) in response to one input value and σi be their variance. In this example, the predicted values are Q-values. The variance σi is resolved into a variance σe representing the epistemic uncertainty and a variance σa representing aleatoric uncertainty.

The variance σe representing the epistemic uncertainty is the variance of the differences of the values μi predicted by individual models from the average of all values predicted by the models. If the models are learned from sufficient data, this variance becomes smaller. Accordingly, it represents the uncertainty caused by shortage of data. On the other hand, the variance σa representing the aleatoric uncertainty is the average of the variances of the values predicted by individual models; it represents the uncertainty caused by the difficulty in prediction using the data. This uncertainty occurs even if the learning has converged, because of the parameters used in the learning and the randomness in data sampling.

Some methods for calculating the epistemic uncertainty and the aleatoric uncertainty are known. For example, a reinforcement learning method obtained by combining the approaches of distributional reinforcement learning and Bayes' inference can calculate not only the Q-values of states and actions but also their aleatoric uncertainties and epistemic uncertainties separately.

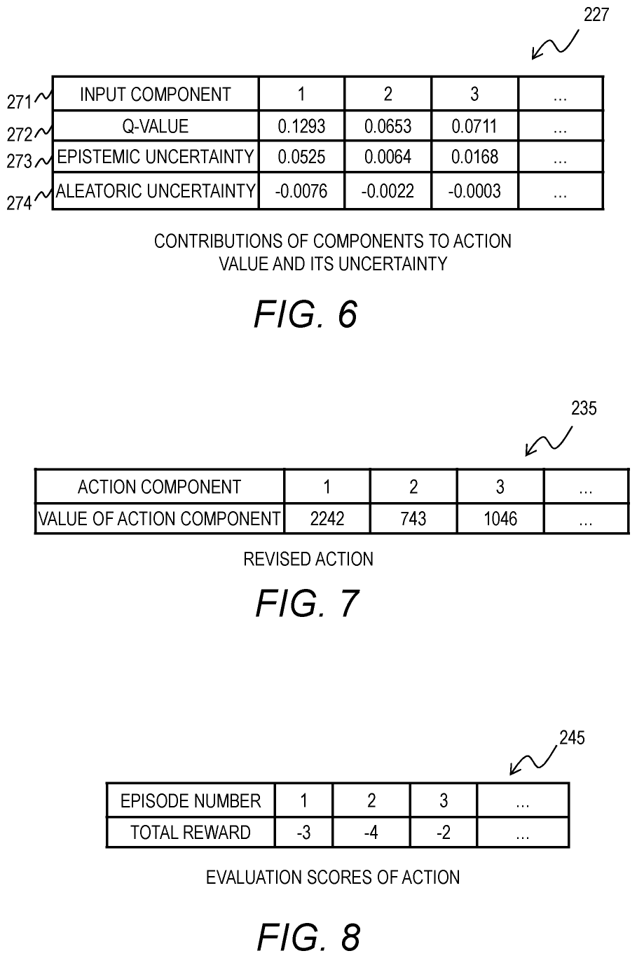

FIG. 6 provides an example of the structure of information included in contributions of components to action value and its uncertainty 227 to be generated by the XAI execution unit 222. The contributions of components to action value and its uncertainty 227 indicate a contribution 272 to the Q-value, a contribution 273 to the epistemic uncertainty, and a contribution 274 to the aleatoric uncertainty of each input component 271.

An input component 271 indicates the identifier of an action component of the predicted action 216 or the identifier of a power generator. Contributions 272, 273, and 274 of an input component to the Q-value, the epistemic uncertainty, and the aleatoric uncertainty are the contributions of the value of the corresponding action component in the predicted action 216 or the output of the corresponding power generator.

When a contribution to the Q-value 272 is a positive or negative value, it means that the contribution of the component increases or decreases the Q-value. When a contribution to the epistemic uncertainty 273 and/or a contribution to the aleatoric uncertainty 274 is a positive or negative value, it means that the contribution of the component increases or decreases the uncertainty. In this example, increase of the Q-value and decrease of the uncertainties are more appropriate for the action.

FIG. 7 provides an example of the structure of information included in a revised action 235 to be proposed by the revised action search unit 231. The revised action 235 indicates revised values of the individual action components. In this example, a revised value of an action component is the output of the corresponding power generator in the next step.

FIG. 8 provides an example of the structure of information included in evaluation scores of original and revised actions 245 to be generated by the action evaluation unit 241. FIG. 8 provides examples of the evaluation scores of an original action or one revised action. The action evaluation unit 241 generates tables having the structure in FIG. 8 individually for an original action and one or more revised actions. There could be a circumstance that no revised action exists.

The evaluation scores of an action 245 indicate total rewards in individual episodes of a simulation. In an embodiment of this specification, the action evaluation unit 241 evaluates each of the action 216 predicted by the action prediction unit 211 and the revised actions 235 proposed by the revised action search unit 231 through a simulation.

Each episode consists of a plurality of steps from a step satisfying a predetermined start condition to a step satisfying a predetermined termination condition. A step includes one action executed by an agent (operation management system 110) under an environment. In this example, an action specifies outputs of power generators and it is included in the state of the next step. In this example, the initial state in each episode is fixed and the states thereafter depend on the results of actions.

Each step exhibits interaction of an environment and an action. For example, each step exhibits an environmental state, an action, and a reward. The current state and the action taken for the state determine the next state. The combination of the environmental state and the action taken for the state determines the reward. In the example of FIG. 8, a total reward is the sum of the rewards in all steps of an episode.

An example of processing of the decision-making support system 100 is described. The decision-making support system 100 presents improvement for the action calculated by a model to the user to support the user's decision-making. The improvement can include a problem to be solved and a specific measure to be taken in order to improve the action.

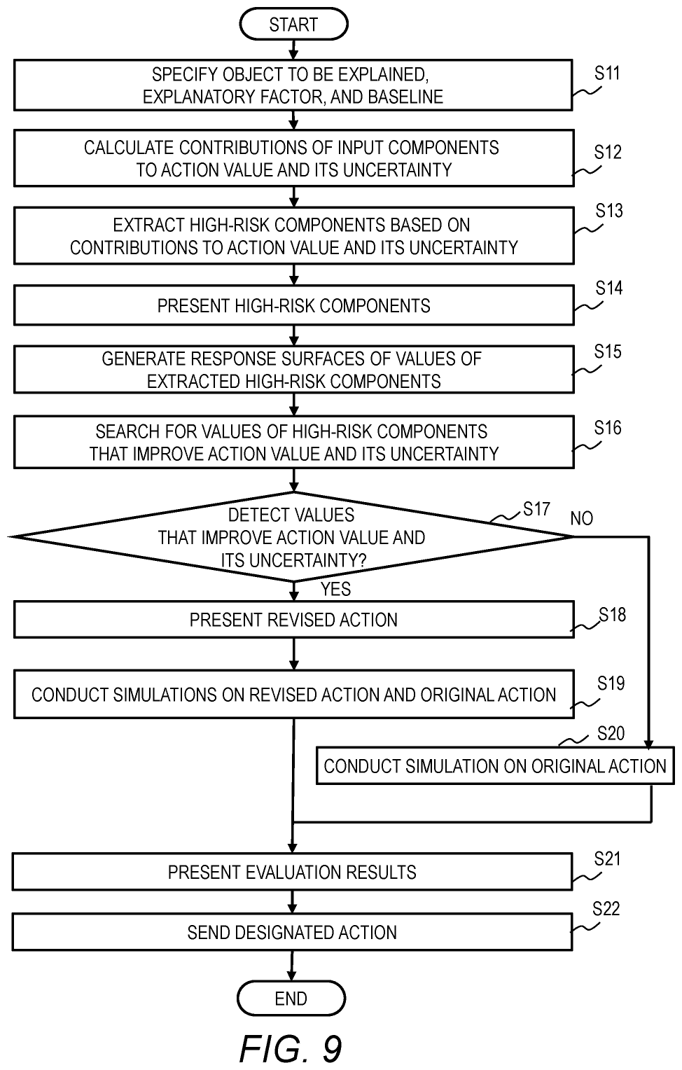

FIG. 9 is a flowchart of an embodiment of the processing in which a reinforcement learning model, specifically a Q-learning model, is applied to power operation management. At Step S11 the XAI configuration unit 223 configures the XAI to analyze risk factors. The XAI configuration unit 223 presents a configuration screen on the user terminal 120 and receives inputs from the user. The items to be specified can include an object to be explained, an explanatory factor, and a baseline. Some of the items can be filled automatically and the other items can be specified by the user.

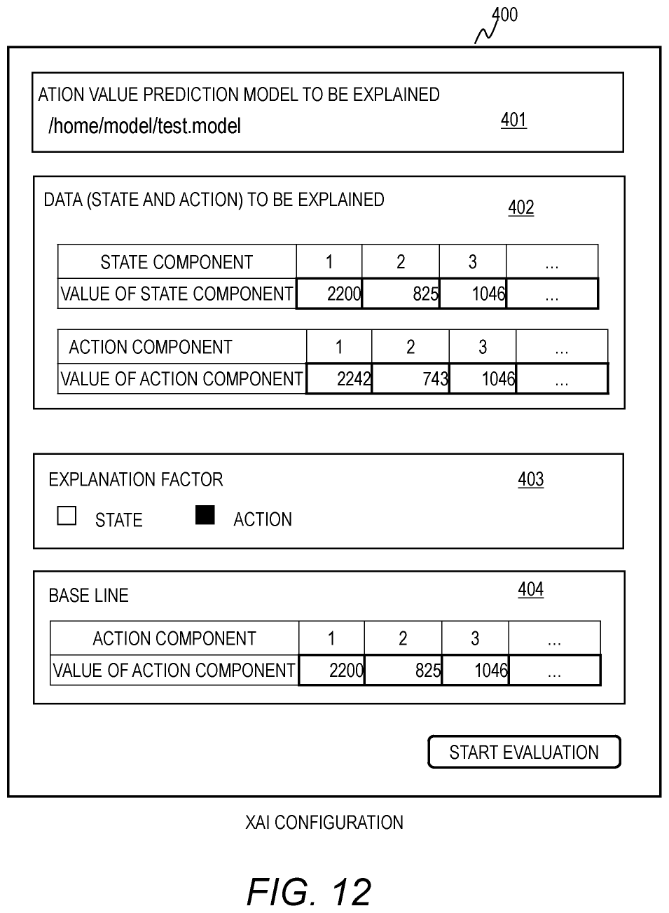

FIG. 12 provides an example of an XAI configuration screen 400. The XAI configuration screen 400 includes a section 401 for indicating an action value prediction model to be explained, a section 402 for indicating data (state and action) to be explained, a section 403 for indicating an explanatory factor, and a section 404 for indicating a baseline.

The action value prediction model and the data (state and action) to be explained are automatically filled by the XAI configuration unit 223. For example, the data to be explained is selected from the current state 215 and the predicted action 216 acquired from the action and action value prediction unit 200. The components of the current state 215 or the predicted action 216 are components to be explained. The explanatory factor can be specified by the user; either the state or the action is selected. When the state is selected, contributions to the state is calculated and combinations of critical state components to be regarded as risk components are extracted. When the action is selected, contributions to the action are calculated, risk components are presented, and thereafter, a revised action is proposed. In the following, an example where the action is selected as an explanatory factor is described.

The baseline is an option for an algorithm that uses a baseline to calculate contributions, like SHAP. For example, when the action is selected as an explanatory factor, the XAI configuration unit 223 displays the section 404 for setting values of action components as a baseline. The default values are of the current action. In the example of power operation management, the current outputs of the power generators are indicated as default values. The user can alter the default values. When the user finds a state and an action to be noted in the system, the user sets its data to the XAI configuration unit 223 and selects the evaluation start button to start evaluation. The item to calculate its contribution can be an environmental variable different from the foregoing examples.

Returning to FIG. 9, in response to the user's instruction to execute evaluation through the XAI configuration unit 223, the XAI execution unit 222 calculates contributions 227 of the input components to the action value and the uncertainty of the action value. As described with reference to FIG. 12, the input components whose contributions are to be calculated by the XAI execution unit 222 are the components of the current state 215 or the predicted action 216.

The calculation of contributions can utilize SHAP, for example. SHAP uses a baseline to be a reference for the calculation of contributions. The XAI execution unit 222 determines a contribution of an input component based on the relative value of the input component to the value of the baseline. In this example, the XAI execution unit 222 calculates contributions of each input component to the action value and the uncertainty of the action value.

For example, the XAI execution unit 222 uses an explanation model that outputs contributions. The explanation model is generated based on the configuration of the action and action value prediction unit 200. The XAI execution unit 222 calculates relative values from the values of input components and the baseline values of the input components. The XAI execution unit 222 inputs the relative values of the input components to the explanation model and calculates contributions of individual input components to each of the action value and the uncertainty of the action value. The calculation of contributions can use an algorithm different from SHAP that does not need a baseline. Various XAI algorithms are widely available; this specification does not provide their detailed description.

At Step S13, the risk factor analysis unit 224 extracts high-risk components based on their contributions to the action value and its uncertainty. In this example, the action value is represented by the Q-value. Further, at Step S14, the risk factor presentation unit 225 presents the high-risk components to the user on the user terminal 120.

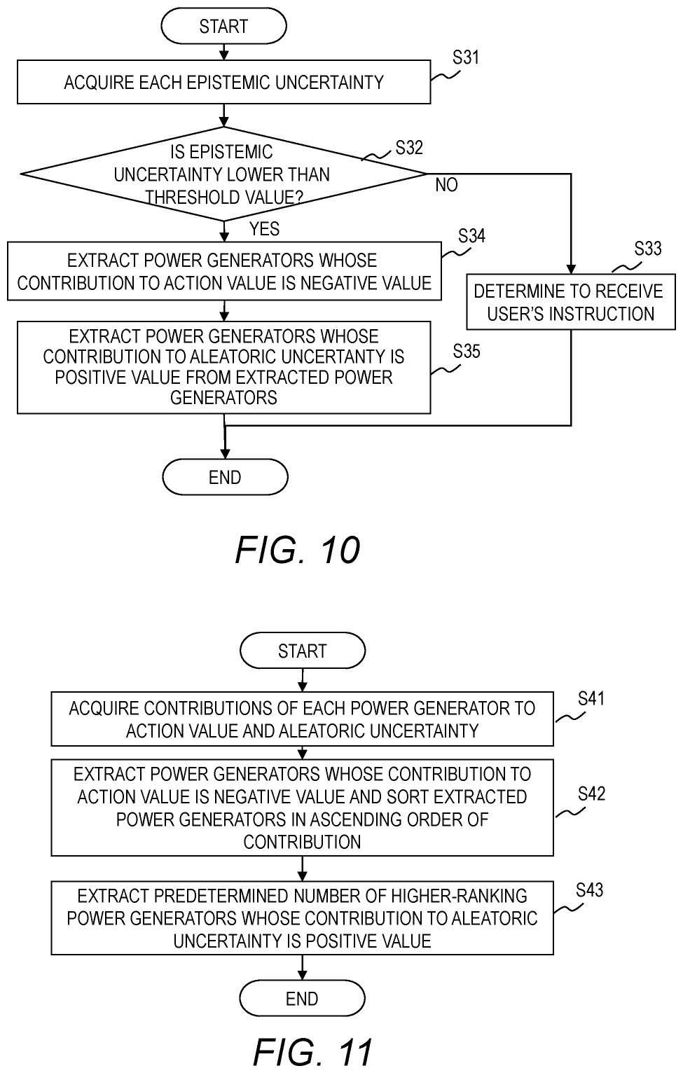

FIG. 10 is a flowchart of an example of the method of extracting high-risk components at Step S13. At Step S31, the risk factor analysis unit 224 acquires epistemic uncertainties calculated by the XAI execution unit 222. At the next Step S32, the risk factor analysis unit 224 compares each epistemic uncertainty with a predetermined threshold value.

If the epistemic uncertainty is not lower than the threshold value (S32: NO), the risk factor analysis unit 224 determines to receive an instruction from the user whether to extract risk components at Step S33. The epistemic uncertainty is caused by insufficient learning; how far the epistemic uncertainty is to be accepted depends on the problem. Accordingly, when the epistemic uncertainty is higher than the threshold value, the risk factor analysis unit 224 receives an instruction from the user about the processing to be performed next, such as continuing to extract risk components or relearning the model. For example, the risk factor presentation unit 225 presents information about the epistemic uncertainty to the user to receive an instruction. This Step S33 can be optional.

If the epistemic uncertainty is lower than the threshold value (S32: YES), the risk factor analysis unit 224 extracts power generators whose contribution to the action value is a negative value at Step S34. At the next Step S35, the risk factor analysis unit 224 extracts power generators whose contribution to the aleatoric uncertainty is a positive value from the power generators extracted at Step S34. Through these steps, the risk factor analysis unit 224 can extract power generators to be risk components appropriately.

FIG. 11 is a flowchart of another example of the method of extracting high-risk components at Step S13. At Step S41, the risk factor analysis unit 224 acquires contributions of each power generator to the action value and the aleatoric uncertainty calculated by the XAI execution unit 222.

At Step S42, the risk factor analysis unit 224 extracts power generators whose contribution to the action value is a negative value and sorts them in the ascending order of contribution. At the next Step S43, the risk factor analysis unit 224 extracts a predetermined number of higher-ranking power generators whose contribution to the aleatoric uncertainty is a positive value. Through these steps, the risk factor analysis unit 224 can extract power generators to be risk components appropriately. The methods of extracting risk factors described with reference to FIGS. 10 and 11 are examples; the risk factor analysis unit 224 can use a method other than the above-described methods.

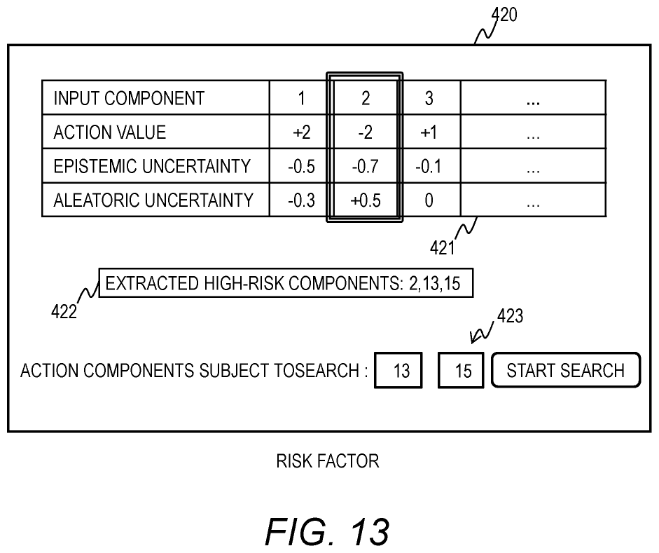

Returning to FIG. 9, the risk factor presentation unit 225 presents the high-risk components extracted by the risk factor analysis unit 224 at Step S14. FIG. 13 provides an example of a risk factor presentation screen 420. For example, the risk factor presentation unit 225 generates a risk factor presentation screen 420 and displays it on the user terminal 120.

In the example of FIG. 13, the risk factor presentation screen 420 includes a table 421 indicating contributions of each input component to the action value and its uncertainty. The table 421 includes identifiers of input components, contribution of each input component to the action value, contribution of each input component to the epistemic uncertainty, and contribution of each input component to the aleatoric uncertainty. In this example, the identifiers of the input components are the same as the identifiers of the power generators.

The risk factor presentation screen 420 further includes a section 422 for indicating the high-risk components extracted by the risk factor analysis unit 224. The way to indicate the high-risk components can be selected desirably. For example, the high-risk components can be highlighted in the table 421 so as to be distinguished from the non-high-risk components. In FIG. 13, the high-risk component 2 is highlighted in the table 421. The way to highlight the high-risk component can be selected desirably.

The risk factor presentation screen 420 further includes a section 423 to receive the user's designation of action components whose values are to be altered for a revised action. In the example of FIG. 13, two action components, specifically, the outputs of power generators #13 and #15, are designated. It can be configured so that any component or only the components that are not determined to be a high-risk component can be designated. Receiving designation by the user enables generation of a revised action in which the values of the components desired by the user are altered.

In response to selection of a search start button, a revised action is searched for, as will be described later. Searching for a revised action searches for an action that improves the action value and its uncertainty by altering the outputs of these power generators from the values in the predicted action 216.

The risk factor presentation screen 420 displays not only the contributions to the action value and the aleatoric uncertainty but also the contribution to the epistemic uncertainty. The user designates an input component that concerns the user to conduct a search. Instead of or in addition to the search for revised actions in which the values of the action components designated by the user are altered, a search for revised actions in which the values of some or all of the extracted high-risk components are altered can be automatically conducted. Altering only the values of high-risk components provides more appropriate revised actions. Not all the information in FIG. 13 has to be presented in the risk factor presentation screen and other information can be added.

Returning to FIG. 9, the revised action search unit 231 generates response surfaces of the values of the extracted high-risk components at Step S15. The extracted high-risk components can be all high-risk components extracted at Step S13 or the high-risk components designated by the user. The revised action search unit 231 generates response surfaces of the values to be referred to in determining a revised action to be proposed.

In the example described herein, the revised action search unit 231 searches for revised actions based on the action value and the aleatoric uncertainty. For this reason, the revised action search unit 231 generates a response surface for each of the action value and the aleatoric uncertainty. The input parameters for the response surface are the values of the extracted high-risk components or the outputs of the extracted power generators. Taking not only the action value but also the uncertainty of the action value into consideration enables more appropriate revised actions to be detected.

At the next Step S16, the revised action search unit 231 searches for values of the high-risk components that improve the action value and the uncertainty. For example, the revised action search unit 231 searches for values of the high-risk components that improve both the action value and the aleatoric uncertainty, or values of the high-risk components that increase the action value and decrease the aleatoric uncertainty.

The action value and the aleatoric uncertainty can have a trade-off relation. Accordingly, the revised action search unit 231 can be configured to receive designation of the user about which is to be weighted. For example, the revised action search unit 231 searches for a revised action that maximizes (action value—a*aleatoric uncertainty). The coefficient a is a positive constant that can be specified by the user.

The revised action search unit 231 can further conduct a search based on the epistemic uncertainty. For example, the revised action search unit 231 searches for actions that improve both the action value and aleatoric uncertainty from the actions exhibiting an epistemic uncertainty lower than a threshold value. Through this processing, actions whose epistemic uncertainty is low, or actions taken during the learning (actions whose safeness is ensured), can be detected. This threshold value can be different or the same as the one in the example described with reference to FIG.

The revised action search unit 231 can search for actions different from the predicted action when the “state” is selected as an explanatory factor in the XAI configuration screen 400 in FIG. 12. In this case, actions whose action value and its aleatoric uncertainty are in their acceptable ranges are to be detected.

At the next Step S17, the revised action search unit 231 determines whether values of the high-risk components (a revised action) that improve both of the action value and the aleatoric uncertainty are detected. If some action that improves the foregoing two items is detected (S17: YES), the revised action presentation unit 232 presents the revised action to the user through the user terminal 120 at Step S18.

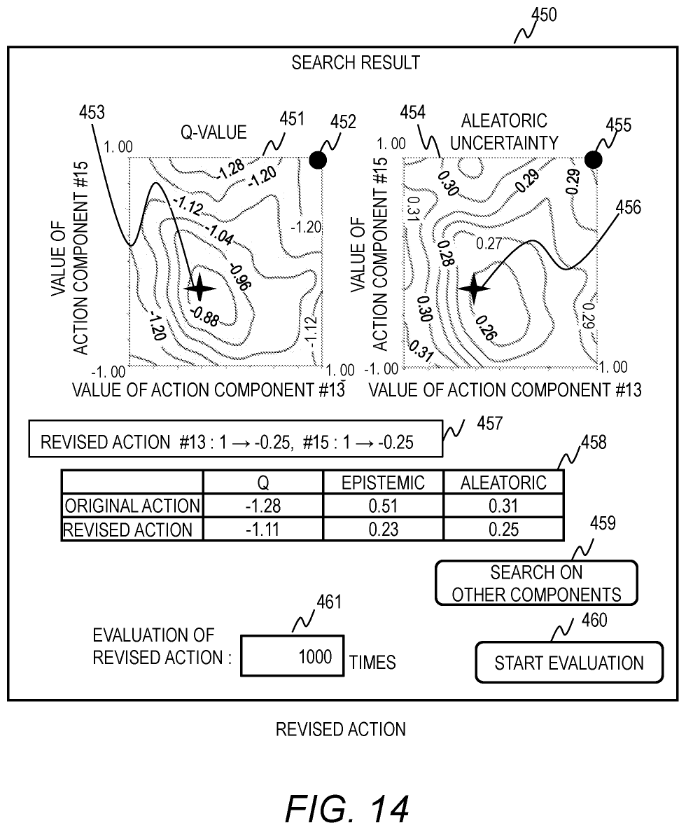

FIG. 14 provides an example of a revised action presentation screen 450 to be generated by the revised action presentation unit 232. In the example of FIG. 14, the power generators #13 and #15 are extracted as high-risk components and a revised action obtained by altering their outputs in the predicted action 216 is detected and proposed.

The revised action presentation screen 450 includes a response surface 451 of the Q-value representing the action value and a response surface 454 of the aleatoric uncertainty. In each of the two response surfaces 451 and 454, the horizontal axis represents the value of the action component (the output) of the power generator #13 and the vertical axis represents the value of the action component (the output) of the power generator #15. In this example, the output of a power generator is calculated by a predetermined function and the revised action presentation screen 450 shows the values of a predetermined parameter of the function that determine the output as the values representing the output of a power generator.

In the response surface 451 of the Q-value, the filled circle 452 represents the coordinates of the outputs of the power generators #13 and #15 in the original action provided in the predicted action 216. The cross mark 453 represents the coordinates of the outputs of the power generators #13 and #15 in the revised action. In the response surface 454 of the aleatoric uncertainty, the filled circle 455 represents the coordinates of the outputs of the power generators #13 and #15 in the original action provided in the predicted action 216. The cross mark 456 represents the coordinates of the outputs of the power generators #13 and #15 in the revised action. The response surfaces 451 and 454 can indicate the region where the epistemic uncertainty is lower than a threshold value by a specific pattern, for example.

The section 457 indicates the outputs of the power generators #13 and #15 in the original action provided in the predicted action 216 and in the proposed revised action. The output of the power generator #13 is changed from 1 to −0.25 and the output of the power generator #15 is changed from 1 to −0.25.

The table 458 indicates the Q-value, the epistemic uncertainty, and the aleatoric uncertainty in each of the original action provided in the predicted action 216 and the proposed revised action. The revised action has improved in the Q-value, the epistemic uncertainty, and the aleatoric uncertainty, compared to the original action.

The user can select the button 459 if the user wants to see another revised action obtained by altering the values of other action components. In response to selection of the button 459, the decision-making support system 100 starts processing from Step S14 in FIG. 9 and displays a risk factor presentation screen 420 on the user terminal 120.

The user can obtain evaluation of each of the original action and the proposed revised action by selecting the evaluation start button 460. The user specifies the number of episodes for the simulation to be conducted for the evaluation in the box 461. In response to the selection of the evaluation start button 460, the revised action evaluation unit 240 executes a simulation including the specified number of episodes on each of the original action and the proposed revised action.

Returning to FIG. 9, the action evaluation unit 241 evaluates the original action and the revised action separately. The action evaluation unit 241 conducts a simulation including the specified number of episodes on each of the original action and the revised action and calculates their evaluation scores 245. As described with reference to FIG. 8, the evaluation scores 245 of the original action or the revised action indicate the sums of the rewards in individual episodes of the simulation on the original action or the revised action. Each sum of the rewards (total reward) represents the action value in the episode.

When taking the balance between supply and demand of the power into consideration, actions that depend on the action of interest need to be altered. Since strict evaluation requires settings reflecting the restrictions incorporated in the environment, in-depth evaluation through a simulation enables generation and presentation of information useful for the user to make a decision.

If a revised action that improves the action value and its uncertainty is not detected at Step S17 (S17: NO), the action evaluation unit 241 conducts a simulation including the predetermined number of episodes on the original action and calculates its evaluation scores at Step S20.

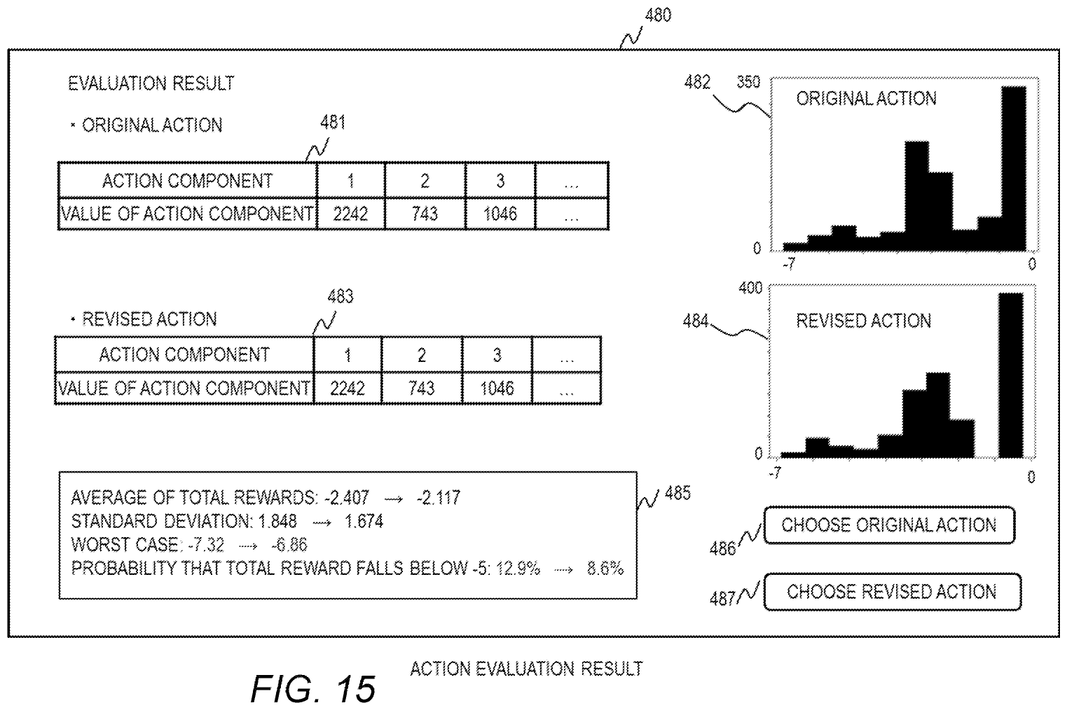

At Step S21, the action evaluation result display unit 242 presents the evaluation results provided by the action evaluation unit 241 to the user. The action evaluation result display unit 242 generates an evaluation result screen and displays it on the user terminal 120. FIG. 15 provides an example of an action evaluation result screen 480. The action evaluation result screen 480 provides evaluation results on both the action (original action) predicted by the action prediction unit 211 and the revised action 235 proposed by the revised action search unit 231.

The table 481 indicates the configuration of the original action, specifically, the identifiers of individual components of the action and the values of the components. In this example, the components of the action are power generators and the values of the components are their outputs. The graph 482 indicates a simulation result on the original action. Specifically, the graph 482 is a histogram of the total rewards in the simulation on the original action. The horizontal axis represents the total reward and the vertical axis represents frequency.

The table 483 indicates the configuration of the revised action, specifically, the identifiers of individual components of the action and the values of the components. In this example, the components of the action are power generators and the values of the components are their outputs. The graph 484 indicates a simulation result on the revised action. Specifically, the graph 484 is a histogram of the total rewards in the simulation on the revised action. The horizontal axis represents the total reward and the vertical axis represents frequency.

The section 485 indicates the information of the comparison between the simulation result on the original action and the simulation result on the revised action. Specifically, the section 485 indicates the statistical information on the total rewards of the original action and the revised action. In the example of FIG. 15, the section 485 provides the average of the total rewards, the standard deviation of the total rewards, the worst case in which the total reward is smallest, and the probability that the total reward falls below −5. The source of an arrow indicates the value of the original action and the destination of the arrow indicates the value of the revised action. These comparison results between two actions effectively support the user in decision-making.

When no revised action is detected that satisfies predetermined conditions, the evaluation result of only the action (original action) 216 predicted by the action prediction unit 211 can be displayed.

The user designates the original action with the button 486 or the revised action with the button 487. Returning to FIG. 9, the action evaluation result display unit 242 sends information on the designated action 246 to the operation management system 110 in response to the designation of the action by the user at Step S22.

It should be noted that this invention is not limited to the above-described embodiments but include various modifications. For example, the above-described embodiments provide details for the sake of better understanding of this invention; they are not limited to those including all the configurations as described. A part of the configuration of an embodiment may be replaced with a configuration of another embodiment or a configuration of an embodiment may be incorporated into a configuration of another embodiment. A part of the configuration of an embodiment may be added, deleted, or replaced by that of a different configuration.

The above-described configurations, functions, and processing units, for all or a part of them, may be implemented by hardware: for example, by designing an integrated circuit. The above-described configurations and functions may be implemented by software, which means that a processor interprets and executes programs providing the functions. The information of programs, tables, and files to implement the functions can be stored in a storage device such as a memory, a hard disk drive, or an SSD (Solid State Drive), or a storage medium such as an IC card or an SD card.

The drawings show control lines and information lines as considered necessary for explanations but do not show all control lines or information lines in the products. It can be considered that most of all components are actually interconnected.

What is claimed is:

1. A computer system comprising:
an arithmetic device; and
a storage device,
wherein the storage device stores a model configured to output an action predicted based on an action value in response to input data,
wherein the arithmetic device is configured to:
acquire data to be explained including values of a plurality of components to be explained in order to explain first prediction processing of the model that outputs a first predicted action in response to first input data;
determine contributions of each of the plurality of components to be explained to an action value and an uncertainty of the action value in the first prediction processing;
detect one or more risk components in the first prediction processing from the plurality of components to be explained based on the contributions; and
present information on the risk components.

2. The computer system according to claim 1, wherein the data to be explained is the first predicted action.

3. The computer system according to claim 1, wherein the arithmetic device is configured to detect one or more components to be explained whose contributions worsen both the action value and the uncertainty of the action value as the risk components.

4. The computer system according to claim 2, wherein the arithmetic device is configured to search for and present a revised action of the first predicted action that improves the action value and the uncertainty of the action value, the revised action being obtained by altering the values of one or more of the components in the first predicted action.

5. The computer system according to claim 4, wherein the one or more of the components are the risk components.

6. The computer system according to claim 4, wherein the one or more of the components are components designated by a user.

7. The computer system according to claim 4, wherein the arithmetic device is configured to:
evaluate the first predicted action and the revised action through a simulation; and
present a result of the evaluation.

8. The computer system according to claim 4,
wherein the uncertainty of the action value is an aleatoric uncertainty of the action value, and
wherein the arithmetic device is configured to search for a revised action from actions exhibiting an epistemic uncertainty of the action value lower than a threshold value.

9. A method to be executed by a system storing a model configured to output an action predicted based on an action value in response to input data, the method comprising:
acquiring, by the system, data to be explained including values of a plurality of components to be explained in order to explain first prediction processing of the model that outputs a first predicted action in response to first input data;
determining, by the system, contributions of each of the plurality of components to be explained to an action value and an uncertainty of the action value in the first prediction processing;
detecting, by the system, one or more risk components in the first prediction processing from the plurality of components to be explained based on the contributions; and
presenting, by the system, information on the risk components.
